(19) United States
(12) Patent Application Publication
(10) Pub. No.: US 2004/0233934 A1
(43) Pub. Date: Nov. 25, 2004

(54) Controlling access to sections of instructions

(76) Inventors: Donald F. Hooper, Shrewsbury, MA (US); Alok Kumar, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/445,168

(22) Filed: May 23, 2003

(51) Int. Cl. H04J 3/24

(52) U.S. Cl. 370/474

(57) ABSTRACT

In general, in one aspect, the disclosure describes a method that includes accessing a semaphore within a first set of semaphores. Individual semaphores within the first set identify whether a thread processing a first packet is blocked from executing sections of instructions associated with the individual semaphores. The method also includes changing the value of at least one semaphore within a second set of semaphores that identify whether a thread processing a second packet is blocked from executing sections of instructions associated with the individual semaphores.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately. For example, the header can include an address that identifies the packet's destination.

A given packet may “hop” across many different intermediate network devices (e.g., “routers”, “bridges” and “switches”) before reaching its destination. These intermediate devices often perform a variety of packet processing operations. For example, intermediate devices often perform address lookup and packet classification to determine how to forward a packet further toward its destination or to determine the quality of service to provide. These devices can perform a wide variety of other operations such as error detection, fragmentation of packets into even smaller packets, and so forth.

### BRIEF DESCRIPTION OF THE DRAWINGS

FIGS. 1A-1E illustrate sets of semaphores associated with different packets.

FIG. 2 illustrates instruction sections associated with a semaphore vector.

FIG. 3 is a diagram illustrating an example of operations performed by a packet processing thread.

FIG. 4 is a flow-chart illustrating thread operation.

FIG. 5 is a diagram illustrating multithreaded processing of packets.

FIG. 6 is a diagram of a network processor.

FIG. 7 is a diagram of a network device.

### DETAILED DESCRIPTION

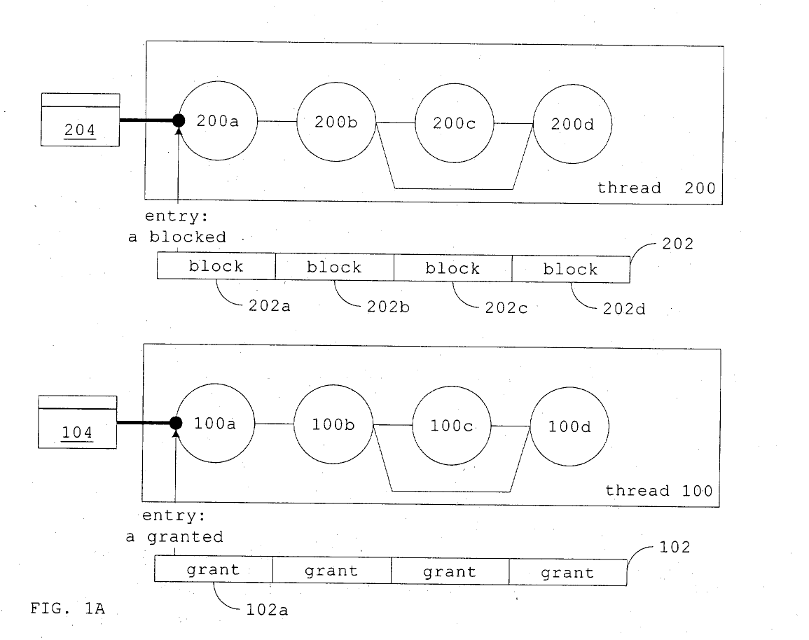

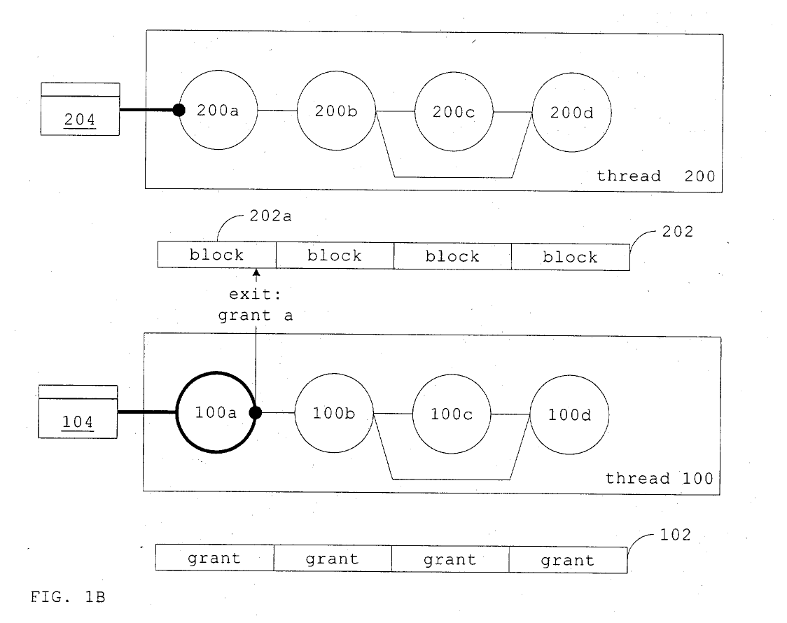

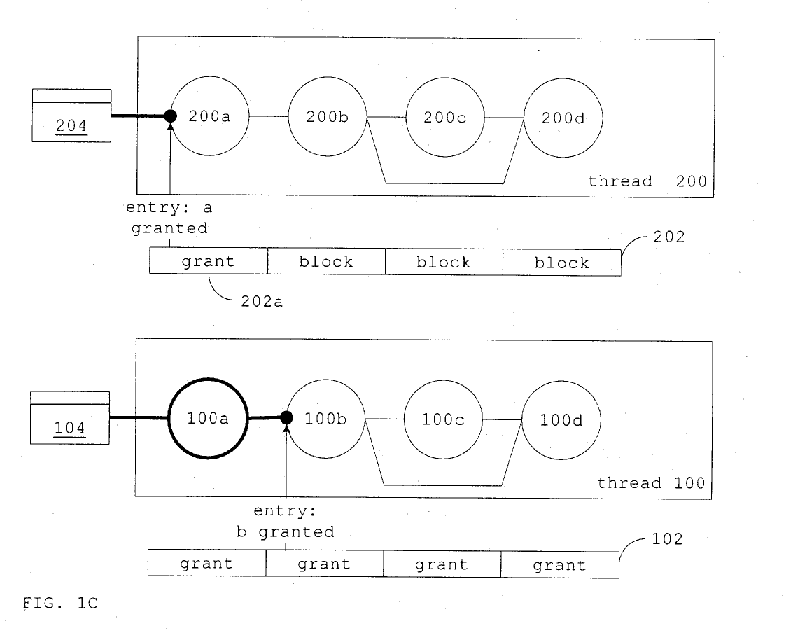

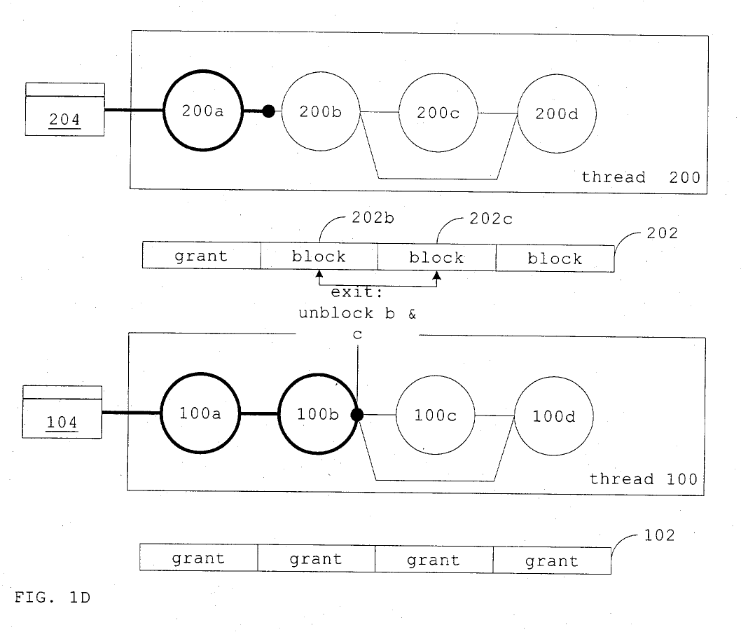

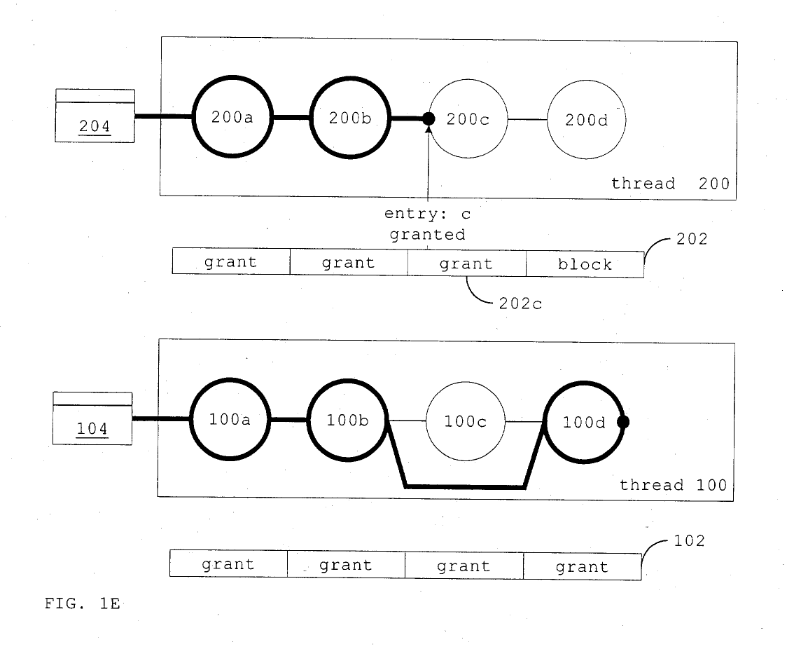

Some network systems provide multiple packet processing threads. For example, in FIG. 1A, thread 100 processes packet 104 while thread 200 processes packet 204. Potentially, different threads 100, 200 may access the same resource(s). For example, assuming packets 104 and 204 are within the same packet flow, threads 100, 200 may both try to update data about the flow. Threads vie for access to these shared resources in sections of instructions known as “critical sections”. These critical sections often create a bottleneck across different threads. That is, one thread's attempted entry into a critical section may be blocked until a different thread exits.

FIGS. 1A-1E illustrate operation of a scheme to control access to resources shared by different threads. As shown in FIG. 1A, a packet 204 being processed by a thread 200 has an associated set 202 of semaphores 202a-202d. Individual semaphores within the set 202 grant or block access to critical sections 200a-200d. For example, thread 200 can examine semaphore 202a to determine whether the thread 200 can enter critical section 200a. Similarly, a different thread (e.g., thread 100) can change the value of one or more of the semaphores 202a-200d to grant or block access to particular critical sections 200a-200d to the thread(s) processing a packet.

Potentially, the different critical sections may need to be performed in a particular order for different packets in a flow (e.g., a Transmission Control Protocol (TCP) connection, Asynchronous Transfer Mode (ATM) circuit, or some common packet classification result). For example, for a device that performs packet header decompression and compression, the compression results of a preceding packet's header may be needed to correctly compress the header of a subsequent packet in the flow. To sequence packet processing operations, the semaphore 102, 202 values associated with different packets 104, 204 may be coordinated such that different threads 102, 202 can proceed concurrently to the extent that the concurrent processing does not perform a critical section for a packet out-of-turn. For example, the semaphores 102, 202 may permit threads 100, 200 to proceed concurrently as long as thread 100 performs critical section operations for packet 104 before thread 200 performs these operations for packet 204.

As shown in FIGS. 1A-1E, as thread 100 proceeds through critical sections 100a-100d for packet 104, the thread 100 frees these sections for the thread(s) 200 processing packet 204 by setting semaphores 202. Potentially, thread 100 may free multiple semaphores at a time, for example, when thread 100 determines that some section(s) need not be executed for packet 104. In other words, instead of needlessly requesting entry and then exiting a series of critical sections to free the corresponding semaphores for the next packet in a flow, thread 100 can simply update semaphores 202. Such a technique can, potentially, free thread 100 for other work such as starting processing of a new packet. Additionally, thread 200 can enter its critical sections 200a-200d sooner. Thus, packet processing cycles can, potentially, be conserved by a simple memory operation. Further, the semaphore set 200 provides thread 100 with “random access” to operation of thread 200. This permits threads to process packets out-of-order to the extent permissible by the ordering requirement of a given protocol.

In greater detail, FIG. 1A depicts a pair of threads 100, 200 that perform packet processing operations for packets 104 and 204 (e.g., Internet Protocol (IP) datagrams, ATM cells, frames, fragments, TCP segments, and so forth). The threads 100, 200 include different critical sections of instructions 100a-100d, 200a-200d. These critical sections may control access to resources shared by the threads 100, 200 such as shared data read and modified by the different threads 100, 200. Potentially, the different threads 100, 200 may operate on copies of the same instructions, though this is not a requirement. For example, different threads 100, 200 may feature instructions to process different kinds of packets requiring different kinds of processing.

Again, the different critical sections may need to be performed in a particular order for different packets in a flow. For example, when reassembling an Internet Protocol (IP) datagram from a series of ATM cells in a buffer, the buffer tail may need to be advanced as the payload of each cell is appended. Other examples include update of Random Early Discard (RED) statistics for a flow, update of a Transfer Control Block (TCB) for a TCP flow, and so forth. To ensure critical section operations are performed for packet 104 before packet 204, semaphore's 102a-102d within semaphore set 102 are “granted” before the corresponding semaphores 202a-202d within semaphore set 202.

The semaphore sets 102, 202 may be implemented as a vector such as a bit-vector where a “0”-bit grants access and a “1”-bit blocks access to a given critical section. Such an implementation can store data of multiple critical sections within a single storage location (e.g., a byte of data can store data for 8 different critical sections). Additionally, the vector can be accessed or updated in a single read or write operation.

Thus, as shown in FIG. 1A, thread 100 checks semaphore 100a to determine whether the thread 100 can perform critical section 100a of instructions for packet 104. Similarly, thread 200 checks semaphore 200a to determine whether thread 200 can perform critical section 200a for packet 204. As shown, while thread 100 is granted entry to critical section 100a, thread 200 remains blocked. Thread 200 may poll semaphore 202a to determine when the block has been lifted. Alternately, or in addition, inter-thread 100, 200 signaling may be used to notify thread 200 when semaphore 202a is freed.

As shown in FIG. 1B, thread 100 frees semaphore 200a, for example, when thread 100 exits, completes, or nearly completes executing code within critical section 100a. For example, instruction(s) of critical section 100b may correspond to a critical section “exit” statement that identifies one or more critical sections that a thread (e.g., thread 200) processing a subsequent packet in the flow should be allowed to enter. As shown in FIG. 1C, after thread 100 frees semaphore 202a, thread 200 can enter critical section 200a while thread 100 continues on to critical section 100b.

Again, a given thread need not perform each critical section 100a-100d, 200a-200d for a given packet. For example, execution flow may branch such that threads 100, 200 may or may not perform critical section 100c, 200c for a given packet. For example, critical section 100c, 200c may perform some multicast operation not needed for unicast packets. As shown in FIG. 1D, thread 100 determines that critical section 100c need not be performed for packet 104. Thus, thread 100 frees semaphores 202b and 202c to permit thread 200 to enter both critical section 200b and 200c if necessary. As shown in FIG. 1E, as thread 100 continues on to critical section 100d, thread 200 can enter critical sections 100b and 100c without delay. Again, granting access to critical section 100c, skipped by thread 100, can conserve processing cycles of both threads 100, 200.

While FIGS. 1A-1E showed a pair of packets 104, 204 and a pair of semaphore vectors 102, 202, a given system may process n packets associated with n corresponding semaphore vectors where the vector associated with a packet is the vector accessed to determine whether a thread can enter an instruction section for that packet. In most implementations, a vector written by a thread (or threads) processing packet x within a flow is read by a thread (or threads) processing packet x+1 of the flow. Thus, though not shown in FIGS. 1A-1E, thread 200 may write to a vector that controls critical section access to the thread(s) processing a third packet, and so forth. In other implementations, semaphore vectors may control entry to instruction sections for more than one packet.

As shown in FIGS. 1A-1E, semaphore bits 102a-102d, 202a-202d within a vector 102, 202 can be ordered to reflect an ordered path through the critical sections. For example, the second semaphore 102b of vector 102 controls access to the second critical section 100b. In other words, the semaphore 102b and section 100b have the same index value of “2”.

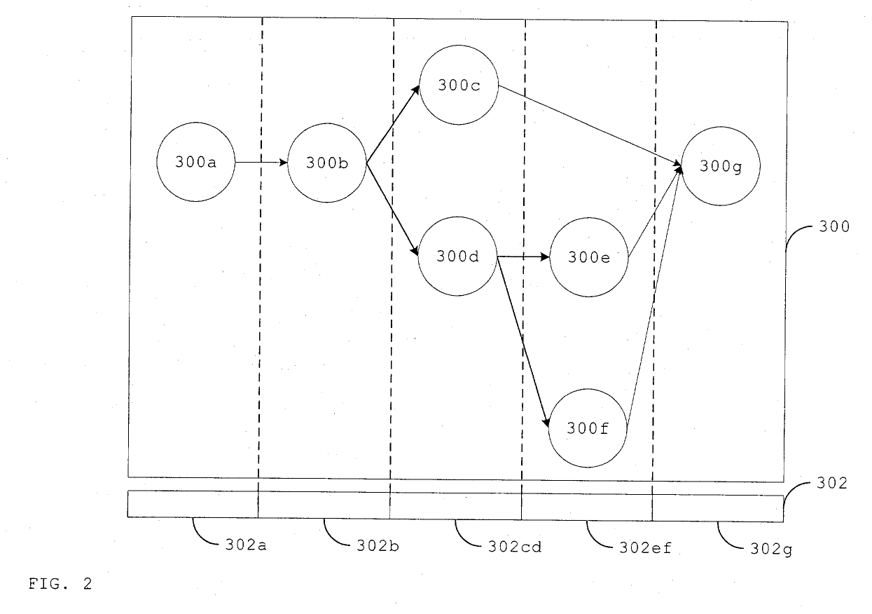

In the case where parallel paths through a “network” of critical sections are possible, different critical sections could be mapped to the same semaphore. For example, FIG. 2 depicts critical sections 300a-300g in a thread 300 that processes IPv4 and IPv6 packets. For IPv4 packets, the thread 300 proceeds through critical sections 300a, 300b, 300c, and 300g. For IPv6 packets, the thread 300 proceeds through critical sections 300a, 300b, 300d, 300e or 300f, and 300g. Where different critical section paths exist, bits within a semaphore vector may be ordered such that each semaphore in the vector represents a critical section in a worst case code path. In the example shown, the worst case code path traverses five critical sections. Thus, the semaphore vector 302 includes five semaphores 302a-302g. As shown, semaphore 302cd may correspond to critical sections 300c or 300d. Similarly, semaphore 302ef may correspond to critical sections 300e or 300f. In such a case, a thread exiting critical section 300c should free semaphores 300cd and 300ef to provide access to critical sections 300c, 300d, 300e, and/or 300f to a thread processing a subsequent packet in the same packet flow.

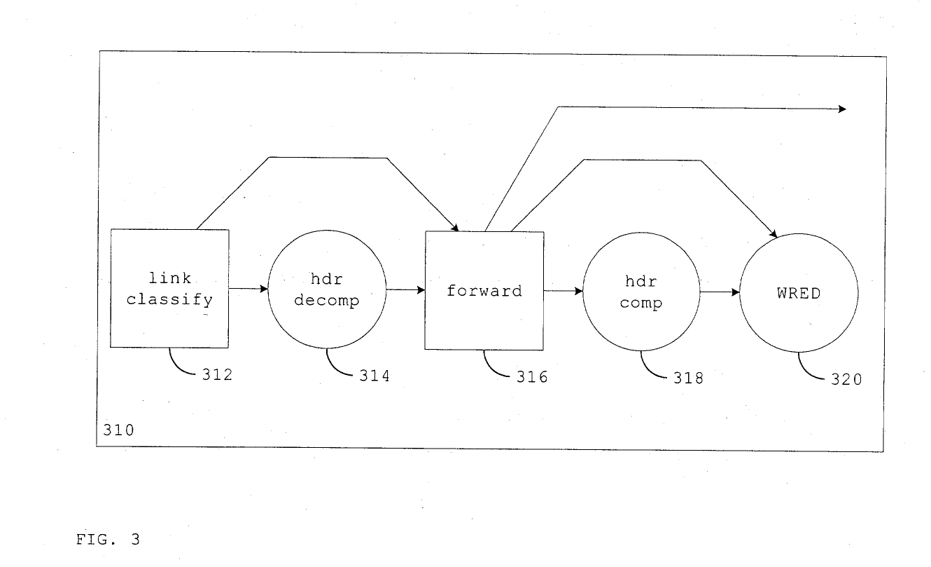

To provide a more detailed example of a thread, FIG. 3 depicts critical sections 312-320 of a sample packet processing thread 310. As shown, the thread 310 includes non-critical (rectangles) and critical (circles) sections of instructions. The thread 310 initially classifies a packet, for example, based on information included in a link layer header (e.g., a network protocol identifier). For example, the header may indicate that the packet includes a compressed network layer header. For such packets, the thread 310 may enter critical section 314 to perform header decompression. Again, the decompression may depend on the contents of the header of the immediately preceding packet in the same flow. Completion, or near completion, of critical section 314 can trigger the thread 310 to free a semaphore controlling access to that critical section 314 for a subsequent packet. For packets not needing header decompression, the thread 310 can skip section 314, update the semaphore for critical section 314 for a thread processing a subsequent flow packet, and advance to non-critical section 316.

As shown, after determining how to forward 316 a packet (e.g., identifying an egress interface), the thread 310 may conditionally perform header compression 318 for packets using compression. In the event that header compression 318 is not performed, the thread 310 may nevertheless free the semaphore controlling entry to critical section 318 for a thread processing a subsequent flow packet without entering the critical section 318 itself. The thread completes with application of a weighted random early discard (WRED) 320 algorithm that discards packets to reduce the likelihood of a network node becoming saturated with traffic.

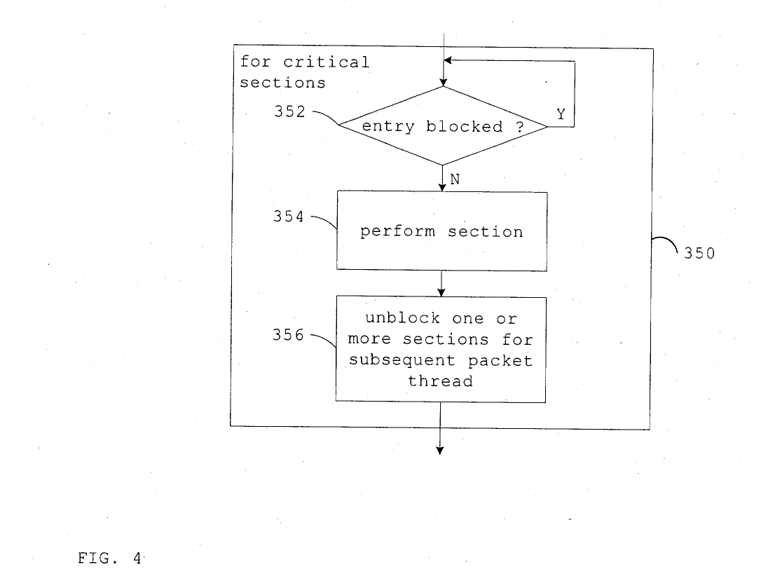

FIG. 4 depicts a flow-chart of thread operation. As shown, a thread 350 determines whether entry to a critical section is blocked 352, for example, by testing the semaphore associated with the section in the packet's associated semaphore vector. For example, thread 350 instructions may be compiled from source code of “entry({semaphore-vector-location},{section-index});”. If blocked, the instructions generated for the source code can poll the semaphore or await some other inter-thread signal indicating the block has been lifted. After gaining access to a critical section, the thread 350 can execute 354 instructions within the section and then unblock 356 one or more semaphores for a subsequently received packet. For example, the thread 350 source code may include an “exit ({semaphore-vector-location-for-subsequent-packet-in-flow}, {section-index1 }[,section-index n]. . . );” statement that results in instructions that grant access by setting the identified semaphores.

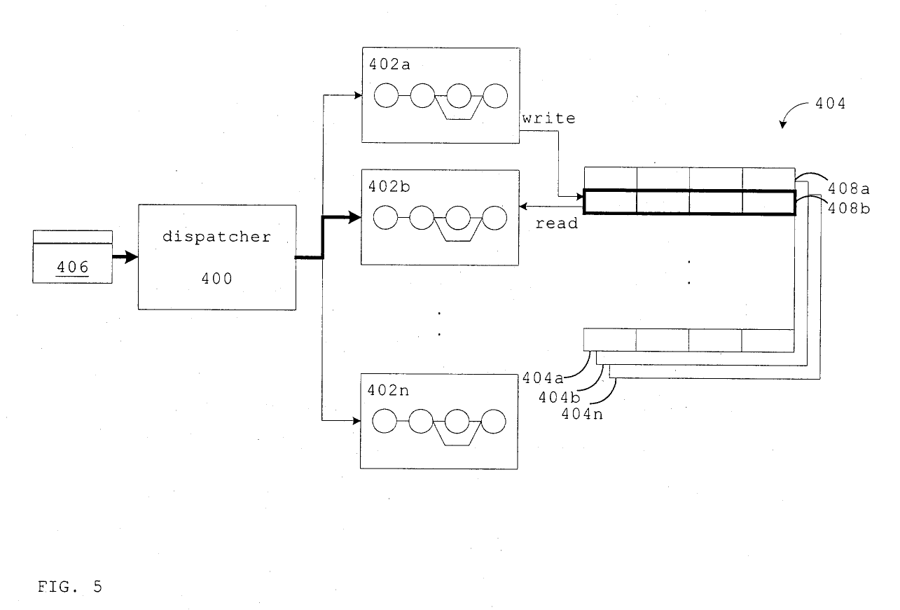

A wide variety of architectures can implement techniques described above. For example, FIG. 5 illustrates a sample implementation that sorts packets into ordered aggregates 404 based on information known near the start of packet processing such as the packet's input port (e.g., an ATM, Ethernet, switch fabric, or Wide Area Network (WAN) port) or by data within a packet (e.g., header data identifying a lower layer protocol, source address, and/or destination address). In other words, packets associated with a given aggregate 404 share some common characteristic. Individual aggregates 404a-404n include an array of semaphore vectors 408 where an individual vector is associated with a particular packet within the aggregate.

As an example, in FIG. 5, entries in aggregate 404a may correspond to packets received from a port “a” (not shown). While aggregating by port. may be relatively coarse, it is sufficient to maintain ordering at a finer level. That is, if packets traveling from the same input port to the same output port are processed in order based on their input port, this ensures that the subset of packets traveling to the same output port are handled in the correct order.

A packet dispatcher thread 400 determines an aggregate 404 for a received packet and allocates an entry within the determined aggregate 404 to store the packet's semaphore vector. The index of the allocated entry within the array may be used as a packet sequence number. For example, semaphore vector 404b having an index/sequence number of “2” corresponds to a packet received after the packet associated with semaphore vector 404a having an index/sequence number of “1”. The indexing may be circular, meaning that the sequence number wraps back to the “0” when the maximum index value is reached.

After allocating an aggregate 404 entry for a packet and, potentially, storing the packet in memory, the dispatcher 400 may then assign the packet to an available thread 402 (or threads). For example, the dispatcher 400 may select a thread based on data (e.g., a register or message wheel) identifying a pool of available threads. The dispatcher 400 may send a message to the selected thread (e.g., thread 402b) identifying the packet to process, the packet's assigned aggregate, and the sequence number within the aggregate allocated to the packet. For example, as shown, the dispatcher allocated aggregate 404a vector 408b for packet 406 received via physical port “a” and assigned the packet 406 to thread 404b for processing. As shown, thread 402b reads vector 408b while thread 404a writes to the vector 408b in the course of processing a previously received packet that arrived via the same port.

Again, threads may vary in their packet processing operations. For example, one set of threads may process ATM packets, another set may process IP packets, while still another set processes Ethernet frames. Thus, the dispatcher may select or configure a thread based on the type of processing to be performed for the packet.

As described, a semaphore vector read by the thread(s) processing one packet is written by the thread(s) processing another. This can be implemented in a variety of ways. For example, in one scenario, a semaphore vector is allocated when a packet (packet “A”) is assigned to a thread (thread “1”) for processing. The allocated vector controls instruction access of a thread (thread “2”) processing a subsequent packet (packet “B”) in the aggregate. Thus, the allocated semaphore vector may be written by thread “1” as thread “1” proceeds through or skips sections of instructions and is read by thread “2” during its processing of packet “B”. In this case, a mechanism informs thread “2” where to find the semaphore vector written by thread “1”.

In another scenario, a semaphore vector is again allocated when a packet (packet “A”) is assigned to a thread (thread “1”) for processing. Unlike the first scenario described above, this vector controls instruction access of thread “1”. That is, the allocated semaphore vector may be read by the thread “1” but is written by a different thread (thread “0”) processing a previous aggregate packet. In this scenario, a mechanism informs thread “0” where to find the semaphore vector read by the thread “1”.

In both scenarios described above a mechanism identifies the location of a semaphore vector to a different thread. A variety of mechanisms may be used to perform this operation. For example, when assigning a packet to a thread, the dispatcher can include a thread ID to be assigned to the next packet or previous packet in an aggregate, depending on the scenario. Subsequent inter-thread communication (e.g., signaling or messaging) permits exchange of the sequence number and aggregate information of the semaphore vectors controlling access for a given packet. A wide variety of other mechanisms may be employed. For example, a given thread may assume that the vector for the previous/subsequent packet is the next/previous entry within the same aggregate.

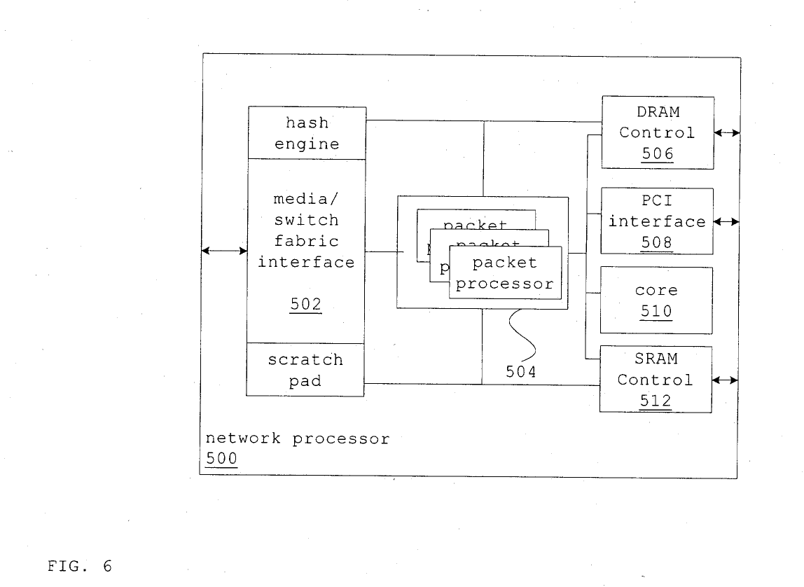

The techniques described above may be used by a variety of network systems. For example, the threads described above may be threads provided by a programmable network processor. FIG. 6 depicts an example of network processor 500. The network processor 500 shown is an Intel® Internet exchange network Processor (IXP). Other network processors feature different designs.

As shown, the network processor 500 features interfaces 502 that can carry packets between the processor 500 and other network components. For example, the processor 500 can feature a switch fabric interface 502 (e.g., a CSIX interface) that enables the processor 500 to transmit a packet to other processor(s) or circuitry connected to the fabric. The processor 500 can also feature an interface 502 (e.g., a System Packet Interface Level 4 (SPI-4) interface) that enables to the processor 500 to communicate with physical layer (PHY) and/or link layer devices. The processor 500 also includes an interface 508 (e.g., a Peripheral Component Interconnect (PCI) bus interface) for communicating, for example, with a host. As shown, the processor 500 also includes other components such as memory controllers 506, 512, a hash engine, and scratch pad memory.

The network processor 500 shown features a collection of packet processors 504. The packet processors 504 may be Reduced Instruction Set Computing (RISC) processors tailored for packet processing. For example, the packet processors may not include floating point instructions or instructions for integer multiplication or division commonly provided by general purpose central processing units (CPUs).

An individual packet processor 504 may offer multiple threads. The multi-threading capability of the packet processors 504 is supported by hardware that reserves different registers for different threads and can quickly swap thread contexts. Packet processors 504 may communicate with neighboring processors 504, for example, using neighbor registers or other shared memory.

The processor 500 also includes a core processor 510 (e.g., a StrongARM® XScale®) that is often programmed to perform “control plane” tasks involved in network operations. The core processor 510, however, may also handle “data plane” tasks and may provide additional packet processing threads.

The packet processing techniques described above may be implemented on a network processor, such as the IXP, in a wide variety of ways. For example, the dispatcher thread may attempt to allocate successive packets within an aggregate to threads provided by the same packet processor 504. If such an assignment is possible, the semaphore vectors may be stored in general purpose registers or local memory offering fast access to threads executing on the packet processor 504.

Potentially, however, the dispatcher thread may not be designed or able to assign packets in the same flow or aggregate to threads on the same packet processor 504. In such circumstances, the vectors may be stored in common memory (e.g., DRAM), though the packet processors may also cache local copies.

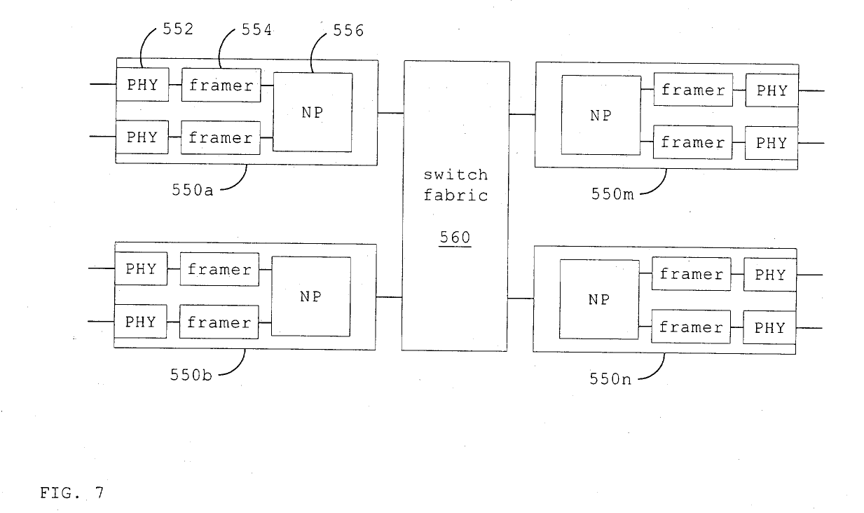

FIG. 7 depicts a network device incorporating techniques described above. As shown, the device features a collection of line cards 550 (“blades”) interconnected by a switch fabric 560 (e.g., a crossbar or shared memory switch fabric). The switch fabric, for example, may conform to CSIX or other fabric technologies such as HyperTransport, Infiniband, PCI-X, Packet-Over-SONET, RapidIO, and Utopia.

Individual line cards (e.g., 550a) include one or more physical layer (PHY) devices 552 (e.g., optic, wire, and wireless PHYs) that handle communication over network connections. The PHYs translate between the physical signals carried by different network mediums and the bits (e.g., “0”-s and “1”-s) used by digital systems. The line cards 550 may also include framer 554 devices (e.g., Ethernet, Synchronous Optic Network (SONET), High-Level Data Link (HDLC) framers or other “layer 2” devices) that can perform operations on frames such as error detection and/or correction. The line cards 550 shown also include one or more network processors 556 that execute instructions to perform packet processing operations for packets received via the PHY(s) 552 and direct the packets, via the switch fabric 560, to a line card providing the selected egress interface. Potentially, the network processor(s) 556 may perform “layer 2” duties instead of the framer 554 devices.

While FIGS. 6 and 7 described a network processor and a device incorporating network processors, the techniques may be implemented in other hardware, firmware, and/or software. For example, the techniques may be implemented in integrated circuits (e.g., Application Specific Integrated Circuits (ASICs), Gate Arrays, and so forth). Additionally, the techniques may be applied to a wide variety of networking protocols and a wide variety of network devices (e.g., a router, switch, bridge, hub, and so forth).

Preferably, the threads are implemented in computer programs such as a high level procedural or object oriented programming language. However, the program(s) can be implemented in assembly or machine language if desired. The language may be compiled or interpreted. Additionally, these techniques may be used in a wide variety of networking environments.

Other embodiments are within the scope of the following claims.

What is claimed is:

1. A method, comprising
accessing a semaphore within a first set of semaphores, individual semaphores within the first set identifying whether a thread processing a first packet is blocked from executing sections of instructions associated with the individual semaphores; and
changing the value of at least one semaphore within a second set of semaphores, individual semaphores within the second set identifying whether a thread processing a second packet is blocked from executing sections of instructions associated with the individual semaphores.

2. The method of claim 1, wherein the changing the value of at least one semaphore within the second set comprises change the values of multiple semaphores within the second set.

3. The method of claim 2, wherein changing the values of multiple semaphores comprises a single write operation.

4. The method of claim 1, wherein the first set of semaphores comprises a bit vector.

5. The method of claim 4, wherein bits within the bit vector are ordered to reflect an ordered path through the sections of instructions.

6. The method of claim 1, further comprising coordinating the values of the first and second set of semaphores to execute the sections of instructions for different packets in an order of packets arrival within a flow.

7. The method of claim 1, wherein the changing comprises changing a semaphore within the second set of semaphore vectors without entering a section of code associated with the semaphore.

8. The method of claim 1, further comprising
accessing a semaphore within the second set of semaphores; and
changing the value of at least one semaphore within a third set of semaphores associated with a third packet.

9. The method of claim 1, further comprising assigning packets to different aggregates.

10. The method of claim 9, wherein assigning the packets comprises assigning based on at least one of the following: ingress port, source address, and destination address.

11. The method of claim 1, wherein the first and second threads comprise execution threads of a network processor.

12. The method of claim 11, wherein the network processor comprises multiple Reduced Instruction Set Computing (RISC) packet processors.

13. A computer program product, disposed on a computer readable medium, the program including instructions for causing a processor to:
access a semaphore within a first set of semaphores, individual semaphores within the first set identifying whether a thread processing a first packet is blocked from executing sections of instructions associated with the individual semaphores; and
change the value of at least one semaphore within a second set of semaphores, individual semaphores within the second set identifying whether a thread processing a second packet is blocked from executing sections of instructions associated with the individual semaphores.

14. The program of claim 13, wherein the instructions for causing the processor to change the value of at least one semaphore within the second set comprise instructions for causing the processor to change the values of multiple semaphores within the second set.

15. The program of claim 13, wherein instructions for causing the processor to change the values of multiple semaphores comprise a single write operation.

16. The program of claim 13, wherein the first set of semaphores comprises a bit vector.

17. The program of claim 16, wherein bits within the bit vector are ordered to reflect an ordered path through the sections of instructions.

18. The program of claim 13, wherein the instructions for causing the processor to change comprise instructions for causing the processor to change a semaphore within the second set of semaphore vectors without entering a section of code associated with the semaphore.

19. The program of claim 13, further comprising instructions for causing a processor to assign packets to different aggregates.

20. A system for processing packets, the system comprising:
at least one physical (PHY) layer device;
at least one processor, the at least one processors providing multiple packet processing threads to operate on packets received via the at least one PHY, at least one of the processors to execute thread instructions for causing the least processor to:
access a semaphore within a first set of semaphores, individual semaphores within the first set identifying whether a thread processing a first packet is blocked from executing sections of instructions associated with the individual semaphores; and
change the value of at least one semaphore within a second set of semaphores, individual semaphores within the second set identifying whether a thread processing a second packet is blocked from executing sections of instructions associated with the individual semaphores.

21. The system of claim 20, wherein the instructions for causing the processor to change the value of at least one semaphore within the second set comprise instructions for causing the processor to change the values of multiple semaphores within the second set.

22. The system of claim 21, wherein instructions for causing the processor to change the values of multiple semaphores comprise a single write operation.

23. The system of claim 20, wherein the first set of semaphores comprises a bit vector.

24. The system of claim 23, wherein bits within the bit vector are ordered to reflect an ordered path through the sections of instructions.

25. The system of claim 20, further comprising instructions for causing assignment of packet to different aggregates.

26. The system of claim 20, wherein the at least one processor comprises more than one processor.

27. The system of claim 26, wherein the more than one processor comprises processors of a network processor.

28. A system comprising:
a crossbar switch fabric,
a set of line cards interconnected by the crossbar switch fabric, individual line cards including at least one physical layer (PHY) device and at least one network processor, the network processor to access instructions for multiple threads to operate on Internet Protocol datagrams received via the at least one PHY,
a first of the threads to perform at least one operation on a first packet of a flow received before a second, subsequently received, packet in the flow, the first of the threads including instructions for causing a one of the at least one processors to:
access a semaphore within a first set of semaphores, individual semaphores within the first set identifying whether the first thread processing the first packet is blocked from executing sections of instructions associated with the individual semaphores; and
change the value of at least one semaphore within a second set of semaphores, individual semaphores within the second set identifying whether a second thread processing the second packet is blocked from executing sections of instructions associated with the individual semaphores.

29. The system of claim 28, wherein an individual line card comprises an Ethernet framer.

30. The system of claim 28, wherein the PHY comprises an optic PHY.
